(19) United States
(12) Patent Application Publication
(10) Pub. No.: US 2024/0043023 A1
(43) Pub. Date: Feb. 8, 2024

(54) VEHICLE EVALUATION SYSTEM

(71) Applicant: TOYOTA JIDOSHA KABUSHIKI KAISHA, Toyota-shi (JP)

(72) Inventor: Hideaki BUNAZAWA, Nagoya-shi (JP)

(73) Assignee: TOYOTA JIDOSHA KABUSHIKI KAISHA, Toyota-shi (JP)

(21) Appl. No.: 18/343,854

(22) Filed: Jun. 29, 2023

(30) Foreign Application Priority Data
Aug. 5, 2022 (JP) 2022-125565

(51) Int. Cl. B60W 50/04; G06N 3/08

(52) U.S. Cl. CPC B60W 50/045; G06N 3/08; B60W 2510/0638; B60W 2050/0057

(57) ABSTRACT

The vehicle evaluation system includes processing circuitry 110 and a storage device 120. The storage device 120 stores data of a learned model that has been trained to generate reference operation data from training sound data. The processing circuitry 110 is configured to execute a generation process and an evaluation process. The generation process is a process that generates generated data, which is data in an operation status, by inputting, to the learned model, evaluation sound data recorded while operating the target vehicle 10 for a predetermined period of time. The evaluation process is a process that compares target operation data, which indicates the operation status of the target vehicle collected simultaneously with the evaluation sound data, with the generated data to evaluate the target vehicle 10 based on the magnitude of deviation between them.

### BACKGROUND

### 1. Field

The present disclosure relates to a vehicle evaluation system that evaluates a vehicle.

### 2. Description of Related Art

Japanese Laid-Open Patent Publication No. 2014-222189 discloses an abnormal sound determination device that determines whether an abnormal sound has occurred using a frequency spectrum of measured sound data. Specifically, the abnormal sound determination device calculates the area of a portion exceeding a threshold level in the frequency spectrum of the measured sound data. The abnormal sound determination device compares the calculated area with a determination value to determine whether an abnormal sound has been generated.

There may be an evaluation system that evaluates a vehicle by analyzing sound data obtained by recording sounds produced from the vehicle. However, the evaluation of a vehicle requires not only identifying a state in which an abnormal sound is generated due to an apparent failure from sound data but also identifying the difference in the state of the vehicle from the sound data. Thus, a vehicle evaluation system suitable for evaluating a vehicle is desired.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A vehicle evaluation system according to an aspect of the present disclosure is configured to evaluate a target vehicle using sound data obtained by recording sounds produced from the target vehicle. The target vehicle is a vehicle to be evaluated. The vehicle evaluation system includes processing circuitry and a storage device. The storage device stores data of a learned model that has been trained using training data. The training data includes training sound data recorded while operating a reference vehicle in a state serving as an evaluation reference for a predetermined period of time and reference operation data indicating an operation status of the reference vehicle collected simultaneously with the training sound data. The learned model has been trained by supervised learning to generate the reference operation data from the training sound data using the training data. The processing circuitry is configured to execute a generation process that generates generated data by inputting, to the learned model, evaluation sound data recorded while operating the target vehicle for the predetermined period of time. The generated data is data in the operation status. The processing circuitry is also configured to execute an evaluation process that compares target operation data with the generated data to evaluate the target vehicle based on a magnitude of deviation between the generated data and the target operation data. The target operation data indicates the operation status of the target vehicle collected simultaneously with the evaluation sound data.

Other features and aspects will be apparent from the following detailed description, the drawings, and the claims.

### BRIEF DESCRIPTION OF DRAWINGS

FIG. 1 is a schematic diagram showing an embodiment of a vehicle evaluation system.

FIG. 2 is a schematic diagram showing the configuration of the vehicle control unit included in the target vehicle to be evaluated by the vehicle evaluation system of FIG. 1.

FIG. 3 is a flowchart of the data acquisition process executed in the vehicle evaluation system of FIG. 1.

FIG. 4 is a flowchart of the data formatting process executed in the vehicle evaluation system of FIG. 1.

FIG. 5 is a flowchart of the training process executed in the vehicle evaluation system of FIG. 1.

FIG. 6 is a flowchart related to the generation process and evaluation process executed in the vehicle evaluation system of FIG. 1.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

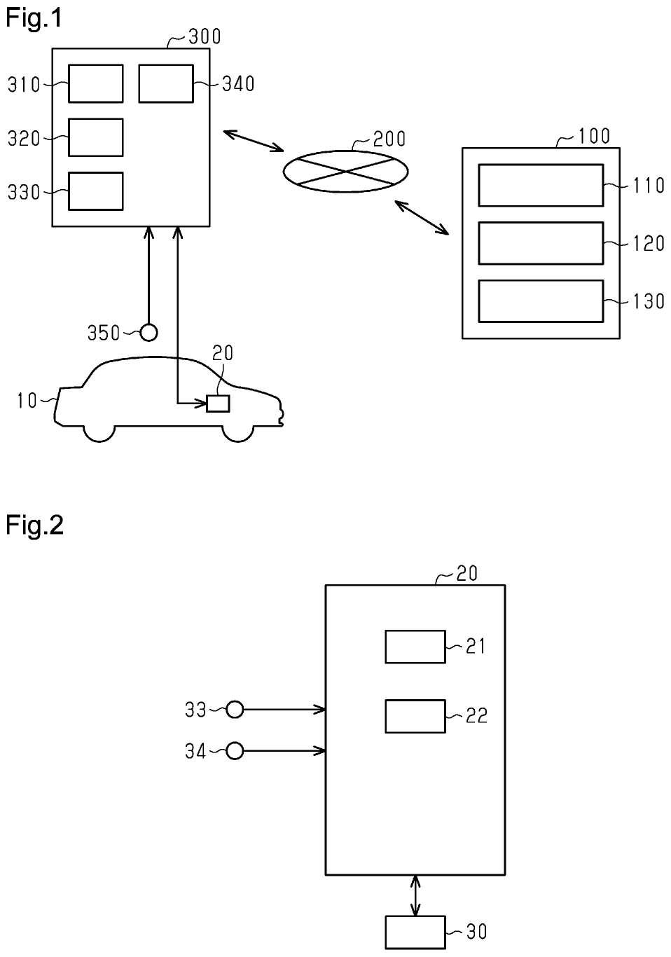

Hereinafter, an embodiment of a vehicle evaluation system will be described with reference to FIGS. 1 to 6.

Configuration of Vehicle Evaluation System

As shown in FIG. 1, the vehicle evaluation system includes a data center 100 and a data acquisition device 300. The data center 100 is communicably connected to the data acquisition device 300 via a communication network 200. As shown in FIG. 1, the data center 100 includes processing circuitry 110 and a storage device 120 that stores a program. The processing circuitry 110 executes the program stored in the storage device 120 to execute various processes. The data center 100 further includes a communication device 130.

The data acquisition device 300 is, for example, a personal computer. The data acquisition device 300 includes processing circuitry 310 and a storage device 320 that stores a program. The processing circuitry 310 executes the program stored in the storage device 320 to execute various processes. The data acquisition device 300 also includes a communication device 330. In this embodiment, the data acquisition device 300 is connected to the data center 100 via the communication network 200 through wireless communication. Further, the data acquisition device 300 includes a display device 340 that displays information. Furthermore, the data acquisition device 300 includes a microphone 350.

To evaluate a target vehicle 10 using the vehicle evaluation system, the microphone 350 is installed at a predetermined position from the target vehicle 10. Further, the data acquisition device 300 is connected to a vehicle control unit 20 of the target vehicle 10. Then, a person controls the target vehicle 10 to operate the target vehicle 10. When the target vehicle 10 is operated in this manner, the data acquisition device 300 records sounds with the microphone 350. The data acquisition device 300 acquires target operation data indicating an operation status of the target vehicle 10 at the same time as recording sound data.

As shown in FIG. 2, the vehicle control unit 20 includes processing circuitry 21 and a storage device 22 that stores a program. The processing circuitry 21 executes the program stored in the storage device 22 to execute various types of control. The vehicle control unit 20 controls components of the target vehicle 10. Various sensors that detect the state of the target vehicle 10 are connected to the vehicle control unit 20. A crank position sensor 34 is connected to the vehicle control unit 20. The crank position sensor 34 outputs a crank angle signal corresponding to a change in the rotation phase of a crankshaft, which is an output shaft of an internal combustion engine mounted on the target vehicle 10. The vehicle control unit 20 calculates an engine rotation speed NE, which is the rotation speed of the crankshaft, based on the crank angle signal. An air flow meter 33 is connected to the vehicle control unit 20. The air flow meter 33 detects an intake air temperature THA, which is the temperature of air drawn into a cylinder through an intake passage of the internal combustion engine mounted on the target vehicle 10, and an intake air amount Ga, which is the mass of air drawn into the cylinder.

The vehicle control unit 20 is connected to a transmission control unit 30 that controls a transmission mounted on the target vehicle 10. The vehicle control unit 20 acquires information related to a speed ratio, an input rotation speed Nin, an output rotation speed Nout, and oil temperature of the transmission from the transmission control unit 30. The input rotation speed Nin is the rotation speed of an input shaft of the transmission. The output rotation speed Nout is the rotation speed of an output shaft of the transmission. When the data acquisition device 300 is connected to the vehicle control unit 20 of the target vehicle 10, the data acquisition device 300 can acquire information related to the target vehicle 10 through the vehicle control unit 20.

Flow of Evaluation by Vehicle Evaluation System

As described above, in the vehicle evaluation system, the data acquisition device 300 is connected to the vehicle control unit 20 of the target vehicle 10 to evaluate the target vehicle 10. While operating the target vehicle 10, the data acquisition device 300 records sounds with the microphone 350. The data acquisition device 300 sends data including data of the recorded sounds to the data center 100. Then, the data center 100 uses the received data to execute an evaluation process that evaluates the target vehicle 10.

The data acquisition device 300 records, in the storage device 320 as evaluation sound data, the data of sounds recorded with the microphone 350 while operating the target vehicle 10 for a predetermined period of time. Further, the data acquisition device 300 stores the intake air temperature THA detected by the air flow meter 33 in the storage device 320, as information of ambient temperature obtained when the sound data is recorded. Furthermore, the data acquisition device 300 stores the target operation data collected simultaneously with the sound data in the storage device 320. Examples of the target operation data include the engine rotation speed NE, the input rotation speed Nin, the output rotation speed Nout, and the gear ratio. Then, the data acquisition device 300 stores, in the storage device 320 as one dataset corresponding to the predetermined period of time, the evaluation sound data, data of the ambient temperature, and the target operation data that have been collected in this manner.

The data acquisition device 300 extracts, from the dataset corresponding to the predetermined period of time stored in the storage device 320, each piece of data in a range of a window Tw having a time width shorter than the predetermined period of time. Then, the data acquisition device 300 formats the data into evaluation data. In a data formatting process that formats the evaluation data, the data acquisition device 300 converts the evaluation sound data into a mel spectrogram by performing frequency analysis on the evaluation sound data, thereby handling the evaluation sound data as image data. The vertical axis of the mel spectrogram represents frequency, shown on the mel scale. The horizontal axis of the mel spectrogram represents time. In the mel spectrogram, intensity is represented by color. In the mel spectrogram, a portion having a lower intensity is represented by a darker blue color, and a portion having a higher intensity is represented by a brighter red color. The sound data included in one dataset corresponding to the predetermined period of time is converted into one mel spectrogram corresponding to the predetermined period of time. The data acquisition device 300 sends the formatted evaluation data to the data center 100. Then, the data center 100 executes the evaluation process by inputting, to a learned model that has been trained by supervised learning, the evaluation sound data included in the evaluation data formatted into lists.

Learned Model

The storage device 120 of the data center 100 stores data of a learned model used to evaluate the target vehicle 10. The data center 100 uses a model partially using ResNet-18, which is an image classification model, to handle the evaluation sound data as image data. ResNet-18 is a pre-trained image classification model learned on the ImageNet dataset. ResNet-18 is trained with the data of over one million images and can classify input images into one thousand categories. The learned model stored in the storage device 120 of the data center 100 is obtained by performing transfer learning on pre-trained ResNet-18. In the learned model, the output layer for classification of ResNet-18 is replaced with a neural network MLP, and the neural network MLP is trained by supervised learning. An input layer Lin of the neural network MLP includes a second input layer Lin2 in addition to a first input layer Lin1 that receives an output from ResNet-18. This allows the vehicle evaluation system to reflect, on the evaluation, data other than the evaluation sound data included in the evaluation data. For example, the input layer Lin of the neural network MLP includes, as the second input layer Lin2, a node that receives the data of ambient temperature.

In the vehicle evaluation system, the data center 100 inputs the evaluation sound data acquired while operating the target vehicle 10 for the predetermined period of time to the learned model, thereby executing a generation process that generates the data of the operation status of the target vehicle 10 as the generated data. The data of the operating state includes the engine rotation speed NE, the input rotation speed Nin, the output rotation speed Nout, and the gear ratio. The output layer Lout of the neural network MLP includes four nodes that output these values.

A training process that trains a model to obtain a learned model will now be described. To learn a model, supervised learning is performed with a vast amount of measurement data collected in advance using a reference vehicle serving as an evaluation reference. In this example, the reference vehicle is a vehicle that has completed a certain period of break-in operation after manufacturing, undergone thorough maintenance and inspection, and has been confirmed to have no abnormalities. That is, the reference vehicle in an extremely good state with almost no deterioration.

Data Acquisition Process

The data acquisition process that acquires measurement data is executed by a computer that can acquire data when connected to the vehicle control unit 20 in the same manner as the data acquisition device 300.

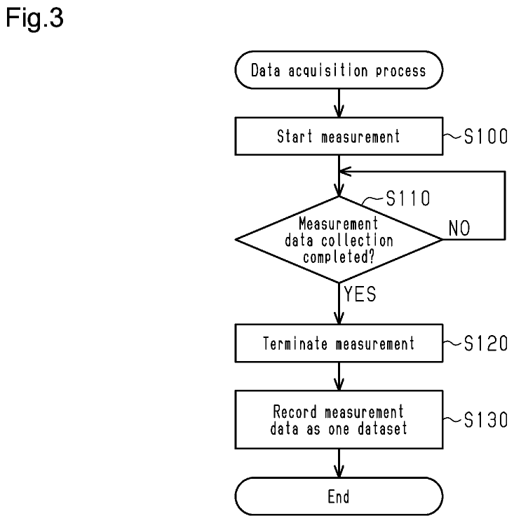

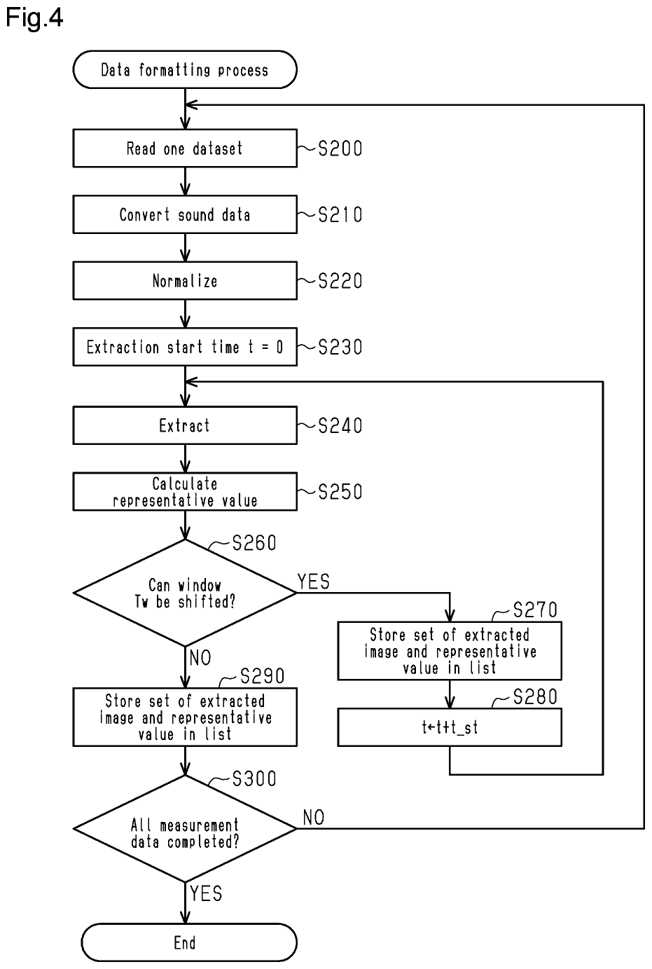

FIG. 3 is a flowchart illustrating the flow of the data acquisition process, which acquires the measurement data. In the following description, the number of each step is represented by the letter S followed by a numeral. The data acquisition process is executed while operating the reference vehicle. As shown in FIG. 3, when starting the data acquisition process, the computer starts measuring data (S100). Then, the computer records sound data with the microphone 350 while operating the reference vehicle, and acquires data of the ambient temperature and reference operation data. The sound data obtained by recording sounds produced from the reference vehicle is training sound data used to train a model. Next, the computer determines whether the measurement data collection for the predetermined period of time is completed (S110). When determining that the measurement data collection is not completed (step S110: NO), the computer repeats the process of S110. When determining that the measurement data collection is completed (S110: YES), the computer advances the process to S120. Then, the computer terminates the data measurement (S120). When terminating the measurement in this manner, the computer records the measurement data corresponding to the predetermined period of time in the storage device as one dataset (S130). Then, the computer temporarily ends the data acquisition process. This completes the acquisition of one dataset. Collection of training data used for supervised learning is performed by collecting a vast number of datasets of measurement data acquired while operating the reference vehicle by performing the data acquisition process many times. The dataset of the measurement data collected in this manner is formatted through a data formatting process illustrated in FIG. 4.

Data Formatting Process

The data formatting process is a process that formats one dataset into lists by extracting the dataset for each range of the window Tw while shifting the window Tw. The data formatting process is performed by a computer. The computer that performs the data formatting process may be the same as the computer that performs the data acquisition process, or may be a different computer.

When starting the data formatting process, the computer first reads one dataset (S200). Next, the computer converts the sound data in the dataset read in the process of S200 into a mel spectrogram (S210). Then, the computer normalizes data other than the sound data that is included in the dataset (S220).

Subsequently, the computer sets an extraction start time t to 0 (S230). Then, the computer extracts the data (S240). That is, the computer sets the start point of the window Tw to the extraction start time t and extracts, from the dataset, the data included in a range within the window Tw. Specifically, the computer extracts, from the mel spectrogram, an image included in the range of the window Tw. Further, the computer extracts data included in the range of the window Tw from each of the data of ambient temperature and the operation status data.

Next, the computer calculates a representative value of the data extracted through the process of S240 (S250). For example, the computer calculates, as the representative value in the window Tw, an average value of the data included in the range of the window Tw. Instead of the average value, a maximum or minimum value may be calculated as the representative value. Then, the computer determines whether the window Tw can be shifted by a stride t_st (S260). The data extraction is repeatedly performed by shifting the window Tw by the stride t_st from the dataset acquired while operating the reference vehicle. When the window Tw reaches the end of the dataset and the data included in the dataset is all extracted, the window Tw is no longer shifted by the stride t_st. When the window Tw cannot be shifted by the stride t_st in this manner, the computer makes a negative determination in the process of the S260.

When determining that the window Tw can be shifted by the stride t_st (S260: YES), the computer stores, in one list, a set of the data of the extracted image and the representative value (S270). When storing the image data in the list, the computer resizes the image data to a size of 224×224, which is suitable for input to ResNet-18. Then, the computer updates the extraction start time t (S280). Specifically, the computer updates the extraction start time t by setting a new extraction start time t to the sum obtained by adding the stride t_st to the extraction start time t. As a result, the window Tw is shifted by the stride t_st. Then, the computer shifts the window Tw by the stride t_st and executes the processes of S240 to S260 again. That is, the computer repeats the processes of S240 to S280 until the window Tw becomes unable to be shifted by the stride t_st.

When determining that the window Tw cannot be shifted (S260: NO), the computer advances the process to S290. The process of S290 is the same as the process of S270. In the process of the S290, when storing the data in the list, the computer determines whether all the read datasets have been processed (S300). When determining that the processing of all the datasets is not completed (S300: NO), the computer returns the process to S200. Then, the computer reads one dataset that has not been processed, and executes the process of S210 and its subsequent processes. When determining that all the datasets have been processed (S300: YES), the computer terminates the series of processes in the data formatting process. In this manner, the computer formats each of prepared datasets of the measurement data into lists. In this manner, the training process is performed to train a model using a vast number of datasets each formatted into a set of lists through the data formatting process.

Training Process

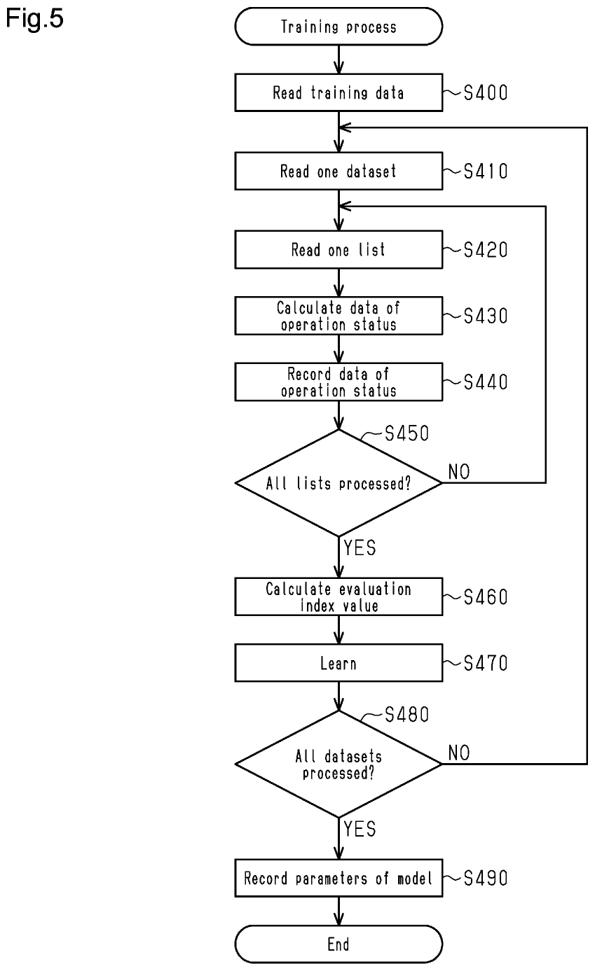

FIG. 5 is a flowchart of the training process. The training process is performed by a computer. A vast number of datasets formatted through the data formatting process is stored as training data in a storage device of the computer that executes the training process. When starting the training process, the computer first reads the training data stored in the storage device (S400). Next, the computer reads one dataset from the read training dataset (S410). Then, the computer reads one list from the dataset (S420).

The computer then inputs, to the above model, the data of the image and the data of the ambient temperature from the data included in the list to calculate the operation status (S430). When the training process is started, the section of ResNet-18 in the model is in a learned state, but the weight and bias of the section of the neural network MLP are initial values. In the training process, the weights and biases of the section of the neural network MLP are updated. Specifically, image data Dw resized to the size of 224×224 included in the list is input to ResNet-18. Then, the representative value of the ambient temperature is input to the second input layer Lin2 of the neural network MLP. As a result, the feature of the image data Dw is extracted through ResNet-18 and input to the first input layer Lin1 of the neural network MLP. Then, the value of the data of the operation state is output from the output layer Lout of the neural network MLP. After calculating the operation status, the computer records the value of the data of the operation status (S440).

Subsequently, the computer determines whether all the lists included in the dataset have been processed (S450). When determining that all the lists have not been processed (S450: NO), the computer returns the process to S420. Then, the computer reads one unprocessed list (S420) and executes the process of S430 and its subsequent processes.

When determining that all the lists have been processed (S450: YES), the computer advances the process to S460. In this manner, the computer calculates the value of the data of the operation status for each list included in the read dataset (S430). The computer then records the calculated values (S440).

In the process of the S460, the computer calculates an evaluation index value. The evaluation index value indicates the magnitude of the deviation between the value calculated through the process of the S430 and the data of the operation status included in the dataset. The data of the operation status included in the dataset is the reference operation data, and is a correct value. In this process, the computer calculates the magnitude of deviation between the value calculated through the process of S430 and the correct value. After calculating the evaluation index value in this manner, the computer performs learning (S470). Specifically, the computer adjusts the weight and bias in the neural network MLP to reduce the evaluation index value using an error back propagation method. Next, the computer determines whether all the datasets included in the read training dataset have been processed (S480). When determining that all the datasets have not been processed (S480: NO), the computer returns the process to S410. Then, the computer reads one unprocessed dataset (S410) and executes the process of S420 and its subsequent processes. The computer repeats the learning to train the model until all the datasets are processed. The computer performs the above supervised learning to train the model such that the model can generate the reference operation data, which indicates the operation state, from the image data and the data of the ambient temperature.

When determining that all the datasets have been processed (S480: YES), the computer records, in the storage device, parameters of the model for which learning using all the datasets has been completed (S490). Then, the computer terminates the series of processes in the training process. Accordingly, the data of the learned model is obtained through the training process. The storage device 120 of the data center 100 stores the data of the learned model that has been trained through the training process in this manner.

The data acquisition process, the data formatting process, and the evaluation process in a case in which the target vehicle 10 is evaluated using the vehicle evaluation system will now be described.

Data Acquisition Process by Data Acquisition Device 300

To evaluate a vehicle using the vehicle evaluation system, the data acquisition device 300 is connected to the target vehicle 10, which is a vehicle to be evaluated, as described above. Further, the microphone 350 is installed in the target vehicle 10. Then, a person controls the target vehicle 10 to operate the target vehicle 10. During operation of the target vehicle 10, the data acquisition device 300 records sounds with the microphone 350. Simultaneously, the data acquisition device 300 acquires data of the ambient temperature. The data acquisition device 300 acquires target operation data indicating the operation status of the target vehicle 10 at the same time as recording sound data. Specifically, the data acquisition device 300 acquires one dataset as the evaluation data by executing the data acquisition process, which has been described with reference to FIG. 3. The sound data included in the evaluation data is the evaluation sound data.

Data Formatting Process by Data Acquisition Device 300

The data acquisition device 300 executes the data formatting process to format the evaluation data. Specifically, the data acquisition device 300 executes the data formatting process, which has been described with reference to FIG. 4, to format the evaluation data into lists. Since only one piece of evaluation data is acquired in the data acquisition process, only one dataset is read and formatted in the data formatting process. The data formatting process is performed to format the evaluation data into lists including the image data Dw, the ambient temperature data, and the target operation data. When the data formatting process is executed to format the evaluation data, the data acquisition device 300 sends the formatted evaluation data to the data center 100.

Evaluation Process by Data Center 100

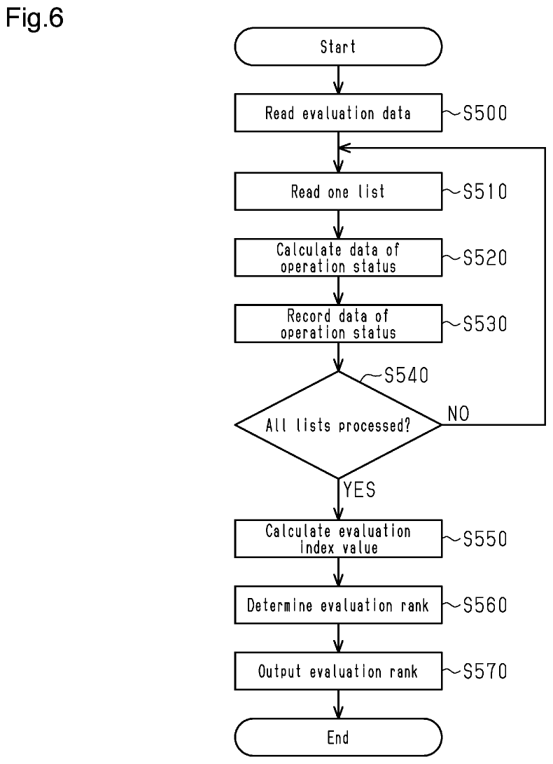

Upon receiving the evaluation data, the data center 100 stores the evaluation data in the storage device 120. Then, the data center 100 executes the evaluation process, which evaluates the target vehicle 10, by executing the routine of FIG. 6. The routine of FIG. 6 is executed by the processing circuitry 110 of the data center 100. As shown in FIG. 6, after starting this routine, the data center 100 reads the evaluation datum stored in the storage device 120 (S500). Then, the data center 100 repeatedly calculates the operation status using the learned model stored in the storage device 120 through the processes of S510 to S540. Specifically, the data center 100 reads one list from the evaluation dataset (S510). In the same manner as the process of S430 in the training process, the data center 100 inputs the list to the learned model and calculates the operation status (S520). After calculating the operation status in this manner, the data center 100 records the calculated operation status (S530).

Next, the data center 100 determines whether all the lists included in the dataset have been processed (S540). When determining that all the lists have not been processed (S540: NO), the data center 100 returns the process to S510. Then, the data center 100 reads one unprocessed list (S510), and executes the processes of step S520 and its subsequent steps. When determining that all the lists have been processed (S540: YES), the data center 100 advances the process to S550.

In this manner, the data center 100 calculates the value of the operation status for each list included in the read evaluation dataset (S520). Then, the data center 100 records the calculated value (S530). The series of processes from S510 to S540 corresponds to the generation process, which inputs the evaluation sound data to the learned model and outputs the generated data. Next, the data center 100 calculates the evaluation index value in the same manner as the process of S460 in the training process (S550). The learned model is optimized to generate the generated data obtained by restoring the reference operation data from the sounds produced from the reference vehicle. Thus, when the evaluation sound data produced from the target vehicle 10 in a state different from the state of the reference vehicle is input to the learned model, the data of the operation state cannot be correctly restored. That is, when the state of the target vehicle 10 deviates from the state of the reference vehicle, deviation occurs between the target operation data, which is stored in the dataset as correct answer data, and the generated data. The evaluation index value indicates the magnitude of the deviation. That is, the larger the evaluation index value is, the more greatly the state of the target vehicle 10 deviates from the state of the reference vehicle. As described above, the reference vehicle is in an extremely good state with almost no deterioration. Accordingly, in the evaluation system, as the evaluation index value becomes smaller, the state of the target vehicle 10 is considered to be closer to the state of the reference vehicle and is thus evaluated to be higher. After calculating the evaluation index value in this manner, the data center 100 advances the process to the S560.

The data center 100 determines an evaluation rank based on the evaluation index value (S560). The data center 100 determines the evaluation rank by selecting an evaluation rank corresponding to the magnitude of the evaluation index value from four evaluation ranks: namely, rank S, rank A, rank B, and rank C. Rank S is an evaluation rank indicating that the vehicle has the highest evaluation level among the four evaluation ranks. Rank C is an evaluation rank indicating that the vehicle has the lowest evaluation level among the four evaluation ranks. The evaluation decreases in the order of rank S, rank A, rank B, and rank C. Rank C is the evaluation rank having the lowest evaluation. After determining the evaluation rank of the target vehicle 10 through the process of the S560, the data center 100 advances the process to the S570. The processes of S550 and S560 correspond to the evaluation process that compares the target operation data with the generated data to evaluate the target vehicle 10 based on the magnitude of the deviation between the target operation data and the generated data.

Next, the data center 100 sends the evaluation rank to the data acquisition device 300 to output the evaluation rank (S570). After outputting the evaluation rank in this manner, the data center 100 terminates the routine.

The data acquisition device 300 that has received the evaluation rank displays the received evaluation rank on the display device 340 as the evaluation rank of the target vehicle 10.

Operation of Present Embodiment

The data center 100 executes the generation process using a learned model to generate generated data that is obtained by restoring control data from the evaluation data. The learned model is a neural network that sets the feature of data extracted from the data corresponding to the predetermined period of time as an explanatory variable and sets the operation status at the point of time corresponding to the extracted data as an objective variable. The data center 100 executes the evaluation process based on the generated data. The reference operation data and the target operation data include the engine rotation speed NE, the input rotation speed Nin, the output rotation speed Nout, and the gear ratio. That is, the reference operation data and the target operation data include data of the rotation speed of a rotation shaft in a power train.

In the evaluation process, the data center 100 calculates, as the evaluation index value, the total sum of the deviation that has been output for each piece of the data repeatedly extracted while changing the extraction start time t. The total sum is a total sum of the deviation for the predetermined period of time. The data center 100 determines the evaluation rank of the target vehicle 10 based on the evaluation index value.

Advantages of Present Embodiment

(1) The difference in state between the target vehicle 10 and the reference vehicle appears in the magnitude of the deviation between the generated data and the target operation data. This allows the vehicle evaluation system to evaluate the state of the vehicle by identifying the difference in the states of the vehicles from the sound data.

(2) The vehicle evaluation system uses image data obtained by performing frequency analysis on sound data. This allows the vehicle evaluation system to efficiently extract the feature included in the sound data and perform the evaluation process.

(3) The vehicle evaluation system analyzes data corresponding to the predetermined period of time by dividing the data into sections. Then, the vehicle evaluation system integrates the results to calculate the evaluation index value. Thus, the size of the learned model is smaller in the vehicle evaluation system than in a case in which data corresponding to the predetermined period of time is collectively analyzed.

(4) The vehicle evaluation system applies the evaluation result to a preset evaluation rank and outputs the evaluation result. This allows the evaluation system to readily recognize the relative level of the target vehicle 10 (whether the state of the target vehicle 10 is good or bad) in a used-car market.

(5) Sound data may be affected by the difference in measurement environment even when the state of the vehicle is the same. In the vehicle evaluation system, the training data and the evaluation data include ambient temperature data. This allows the vehicle evaluation system to perform evaluation while reflecting the influence of the difference in the ambient temperature.

(6) A method may be used to compare sound data measured in the reference vehicle with sound data measured in the target vehicle 10 and calculate the degree of deviation between these types of sound data as an evaluation index value. However, in such a method, when variations occur in the measurement conditions due to different controls performed by operators, variations occur in the sound data. Thus, in such a method, the influence of variations in the measurement conditions is reflected on the evaluation index value. The vehicle evaluation system of the above embodiment uses the evaluation data collected by operating the target vehicle 10. Further, the vehicle evaluation system compares the target operation data included in the evaluation data with the generated data generated by using the evaluation sound data. This reduces the influence of variations in the measurement conditions.

Modifications

The present embodiment may be modified as follows. The present embodiment and the following modifications can be combined as long as they remain technically consistent with each other.

The data formatting process may be executed by the data center 100.

The data used as the measurement data and the evaluation data is not limited to a mel spectrogram. For example, a spectrogram obtained by performing wavelet transform on sound data may be used. Instead, a spectrogram obtained by performing short-time Fourier transform on sound data may be used. Sound data does not have to be converted into image data. For example, a feature may be extracted from sound data, and the feature may be used as measurement data and evaluation data. This eliminates the need for ResNet-18, which handles image data, as a model used for the evaluation process. Although a model obtained by performing transfer learning on ResNet-18 has been explained as an example of the learned model, the model does not need to have such a configuration. The learned model only needs to output the generated data based on the evaluation data.

The number of evaluation ranks does not have to be four. For example, the number of evaluation ranks may be larger or smaller than four. Although the example in which the evaluation rank is determined based on the evaluation index value has been described as the evaluation process, the evaluation process is not limited to such an example. For example, the evaluation index value may be output as a value indicating a lower evaluation as the value increases, and may be displayed on the display device 340.

In the vehicle evaluation system, the target vehicle 10 is evaluated using a vehicle in an extremely good state as the reference vehicle. However, the reference vehicle is not limited to a vehicle in a relatively good state. For example, the reference vehicle may be in an extremely bad state and have low evaluation. The evaluation index value in the evaluation process indicates the degree of deviation between the state of the reference vehicle and the state of the target vehicle 10. Thus, when the reference vehicle is a deteriorated vehicle having an extremely low evaluation, the evaluation decreases as the evaluation index value decreases. The target vehicle 10 may be evaluated using such an evaluation index value.

The vehicle evaluation system may only include the data center 100 that performs the generation process and the evaluation process. In this case, the vehicle evaluation system performs the generation process and the evaluation process using the received evaluation data to output the evaluation result. In addition, for example, the data of the learned model may be stored in the storage device 320 of the data acquisition device 300, and the vehicle evaluation system may only include the data acquisition device 300. In this case, the generation process and the evaluation process are executed in the data acquisition device 300.

The data acquisition device 300 does not have to include the microphone 350. The vehicle evaluation system may acquire sound data from an external device and perform the data formatting process, the generation process, and the evaluation process. The generation process and the evaluation process may be performed using pieces of sound data recorded using microphones 350.

In the embodiment, the example in which the vehicle evaluation system evaluates the target vehicle 10 has been described. Instead, the vehicle evaluation system may evaluate the target vehicle 10 by evaluating a specific unit in the target vehicle 10. For example, the vehicle evaluation system may evaluate the state of a transmission mounted on the target vehicle 10 using sound data obtained by recording sounds produced from the transmission.

In the above embodiment, the data center 100 of the vehicle evaluation system includes the processing circuitry 110 and the storage device 120, and executes software processing using these components. Further, the data acquisition device 300 of the vehicle evaluation system includes the processing circuitry 310 and the storage device 320, and executes software processing using these components. However, this is merely exemplary. For example, the vehicle evaluation system may include a dedicated hardware circuit (such as ASIC) that executes at least part of the software processes executed in the above-described embodiments. That is, the above processes may be executed by processing circuitry that includes at least one of a set of one or more software execution devices and a set of one or more dedicated hardware circuits. The storage device (i.e., computer-readable medium) that stores a program includes any type of media that are accessible by general-purpose computers and dedicated computers.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. A vehicle evaluation system configured to evaluate a target vehicle using sound data obtained by recording sounds produced from the target vehicle, the target vehicle being a vehicle to be evaluated, the vehicle evaluation system comprising:
processing circuitry; and
a storage device, wherein
the storage device stores data of a learned model that has been trained using training data,
the training data includes:
training sound data recorded while operating a reference vehicle in a state serving as an evaluation reference for a predetermined period of time; and
reference operation data collected simultaneously with the training sound data and indicating an operation status of the reference vehicle,
the learned model has been trained by supervised learning to generate the reference operation data from the training sound data using the training data, and
the processing circuit is configured to execute:
a generation process that generates generated data by inputting, to the learned model, evaluation sound data recorded while operating the target vehicle for the predetermined period of time, the generated data being data of the operation status; and
an evaluation process that compares target operation data with the generated data to evaluate the target vehicle based on a magnitude of deviation between the generated data and the target operation data, the target operation data collected simultaneously with the evaluation sound data and indicating the operation status of the target vehicle.

2. The vehicle evaluation system according to claim 1, wherein the learned model is configured to generate the generated data from evaluation sound data including image data of a spectrogram obtained by performing frequency analysis on the sound data.

3. The vehicle evaluation system according to claim 1, wherein the learned model is a neural network that sets a feature of data extracted from data corresponding to the predetermined period of time as an explanatory variable and sets the operation status at a point of time corresponding to the extracted data as an objective variable.

4. The vehicle evaluation system according to claim 3, wherein the evaluation process includes calculating, as an evaluation index value, a total sum of the deviation that has been output for each piece of the data repeatedly extracted while changing an extraction start time, the total sum being a total sum of the deviation for the predetermined period of time.

5. The vehicle evaluation system according to claim 1, wherein each of the reference operation data and the target operation data includes data of a rotation speed of a rotation shaft in a power train.
